(19) United States
(12) Patent Application Publication
(10) Pub. No.: US 2016/0150422 A1
(43) Pub. Date: May 26, 2016

(54) Wifi Home Phone to Cell

(71) Applicant: Michael Lewis Moravitz, Fairfax, VA (US)

(72) Inventor: Michael Lewis Moravitz, Fairfax, VA (US)

(21) Appl. No.: 14/998,525

(22) Filed: Jan. 19, 2016

(51) Int. Cl. H04W 24/02

(52) U.S. Cl. CPC H04W 24/02

(57) ABSTRACT

Building on my previous patent application for a WiFi Home Phone, this idea would connect the numbers of the home phone to the cell phone.

A WiFi home phone can be created—bringing down the satellite signal for convenience while also connecting to your cell phone by the same number. This would simplify home and cell phone numbers for many people who would want such a convenience. WiFi with laptops—and the ubiquity of satellite phones—show the utility of this technology, but it can be both expanded and rationalized. Some may prefer separate numbers for separate members of a family, but a single main number that also connects to a cell through WiFi may be quite practical—rather than checking for messages or programming one's cell in inscrutable ways. As I pointed out in the previous application for the WiFi home phone, such a device might be less expensive regarding telephone infrastructure, such as phone lines and cables.

This latest patent application clarifies numbers and devices—and somewhat lifestyles.

1) Patents for Cell Phones;

2) My patent application for WiFi Home phone—29/463,833.
